(19) United States
(12) Patent Application Publication
(10) Pub. No.: US 2010/0195855 A1
(43) Pub. Date: Aug. 5, 2010

(54) METHOD AND APPARATUS FOR IMPROVING THE SIGNAL-TO-NOISE RATIO OF A MEASURING SIGNAL DETECTED BY A HEARING DEVICE

(75) Inventors: Matthias Müller-Wehlau, Erlangen (DE); Andre Steinbuss, Erlangen (DE)

Correspondence Address: LERNER GREENBERG STEMER LLP, P O BOX 2480, HOLLYWOOD, FL, 33022-2480, US

(73) Assignee: SIEMENS MEDICAL INSTRUMENTS PTE. LTD., Singapore (SG)

(21) Appl. No.: 12/689,350

(22) Filed: Jan. 19, 2010

(30) Foreign Application Priority Data
Feb. 5, 2009 (DE) 10 2009 007 512.7

(51) Int. Cl. H04R 25/00

(52) U.S. Cl. 381/317

(57) ABSTRACT

An apparatus and an associated method for improving the signal-to-noise ratio of a measuring signal emitted and detected by a hearing device include a generator unit for generating a measuring signal, a modulation unit for modulating the measuring signal prior to or during emission in such a way that the detected measuring signal is modulated according to the generated measuring signal, and a detection unit for detecting the measuring signal on the basis of the modulation. The result of a measurement, for instance an OLG measurement, is therefore more independent of external disturbances and the signal-to-noise ratio is increased.

### CROSS-REFERENCE TO RELATED APPLICATION

This application claims the priority, under 35 U.S.C. §119, of German Patent Application DE 10 2009 007 512.7, filed Feb. 5, 2009; the prior application is herewith incorporated by reference in its entirety.

### BACKGROUND OF THE INVENTION

### Field of the Invention

The invention relates to a method for improving a signal-to-noise ratio of a measuring signal acoustically emitted and acoustically detected by a hearing device. The invention also relates to an apparatus for improving a signal-to-noise ratio of a measuring signal acoustically emitted and detected by a hearing device.

If acoustic couplings exist in a hearing device between a microphone and a receiver, feedback effects, for instance “whistling” for instance, may occur. FIG. 1 shows a schematic and block representation of a hearing device 1 with an acoustic feedback. The hearing device 1 is located in an acoustic environment. A signal 7 received by a microphone 2 of the hearing device 1 is amplified inter alia in a signal processing unit 5 and is emitted again by way of a receiver 3 of the hearing device 1. An acoustic coupling from the receiver 3 back to the microphone 2 takes place by way of a physical feedback path 4. The received signal 7 thus is formed of the total of an incident useful signal 6 and a signal across the feedback path 4. As a result of the feedback, feedback whistling occurs if both the amplitude as well as the phase condition are fulfilled. Sound artifacts nevertheless already appear if those conditions are only approximately fulfilled.

One method of suppressing feedback relates to measuring an open-loop gain (OLG) and determining a maximum amplification therefrom. FIG. 2 shows a block diagram for measuring an OLG. In that case, the signal path of a hearing device 1 is separated upstream and downstream of a signal processing unit 5 through the use of first and second switches 10, 11. Test tones of different frequencies or noises are generated in a tone generator 8 of the hearing device 1, emitted by way of a receiver 3 and received by a microphone 2 by way of a feedback path 4.

The level of the received, fed-back signal is determined upstream of the first switch 10 through the use of a level gauge 9. A difference relative to the original level of the test tones and/or noise is shown by the OLG, on the basis of which the maximum possible amplification of the hearing device 1 can be determined without feedback whistling (feedback threshold). In order to obtain a precise measurement result, it is necessary to achieve as high a signal-to-noise ratio of the received, fed-back signal as possible. To that end, a high transmission level of the test tones is needed. The loud test tones and/or noises are, however, perceived by some hearing device wearers to be unpleasant and irritating.

In addition to test tones and noises as a measuring signal for an OLG measurement, other measuring signals for measuring further hearing device parameters are also conceivable.

### SUMMARY OF THE INVENTION

It is accordingly an object of the invention to provide a method and an apparatus for improving the signal-to-noise ratio of a measuring signal detected by a hearing device, which overcome the hereinafore-mentioned disadvantages of the heretofore-known methods and apparatuses of this general type.

With the foregoing and other objects in view there is provided, in accordance with the invention, a method for improving a signal-to-noise ratio of a measuring signal acoustically emitted and acoustically detected by a hearing device. The method comprises modulating the measuring signal through the hearing device prior to or during emission, and detecting the acoustically emitted, modulated measuring signal through the hearing device on a basis of the modulation.

The result of a measurement using a measuring signal is therefore more dependent on external disturbances and the signal-to-noise ratio is increased.

In a development of the invention, the emitted measuring signal can be acoustically emitted by the hearing device. As a result, a measurement using sound waves is possible.

In accordance with another mode of the invention, the modulation can take place through the use of amplitude modulation or by reducing the amplitude to zero and thus by adding signal gaps.

In accordance with a further mode of the invention, the modulation can preferably take place through the use of phase modulation and/or frequency modulation.

In accordance with an added mode of the invention, the measuring signal can be separately detected in different frequency bands.

In accordance with an additional mode of the invention, the measuring signal can be a measuring signal for an OLG measurement. This has the advantage of offering a reliable OLG measurement which is less stressful for a hearing device wearer.

With the objects of the invention in view, there is also provided an apparatus for improving the signal-to-noise ratio of a measuring signal emitted and detected by a hearing device. The hearing device comprising a generator unit for generating a measuring signal, a modulation unit for modulating the measuring signal prior to or during emission so as to modulate the detected measuring signal according to the generated measuring signal, a detection unit for detecting the measuring signal on a basis of the modulation, a receiver for acoustically emitting the modulated measuring signal, and a microphone for receiving the modulated measuring signal emitted by the receiver.

In accordance with another feature of the invention, the measuring signal can be modulated by the modulation unit in terms of its amplitude and/or phase and/or frequency.

In accordance with a further feature of the invention, the measuring signal can be modulated by the modulation unit by reducing the amplitude to zero and thus by adding signal gaps.

With the objects of the invention in view, there is furthermore provided a hearing device with an apparatus according to the invention and with a receiver for acoustically emitting the modulated measuring signal and a microphone for receiving the modulated measuring signal emitted by the receiver.

In accordance with another feature of the invention, the measuring signal can be a measuring signal for an open-loop gain measurement in a hearing device.

With the objects of the invention in view, there is concomitantly provided a computer program product with a computer program, which includes software measures for implementing a method according to the invention, if the computer program is executed in a control unit.

Other features which are considered as characteristic for the invention are set forth in the appended claims.

Although the invention is illustrated and described herein as embodied in a method and an apparatus for improving the signal-to-noise ratio of a measuring signal detected by a hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic and block diagram illustrating the principle of an acoustic feedback in hearing devices according to the prior art;

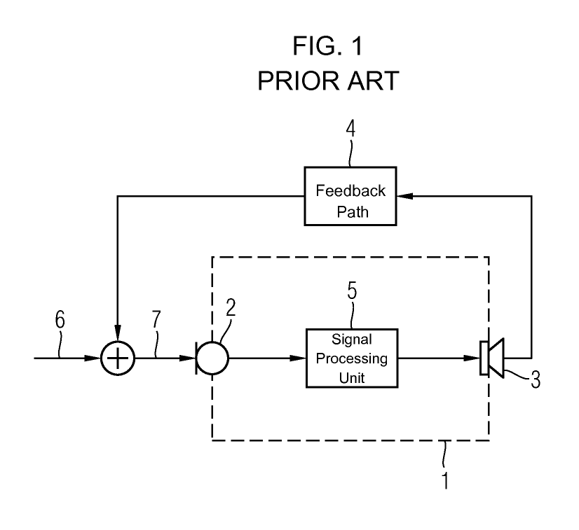

FIG. 2 is a schematic and block diagram of an OLG measurement in hearing devices according to the prior art; and

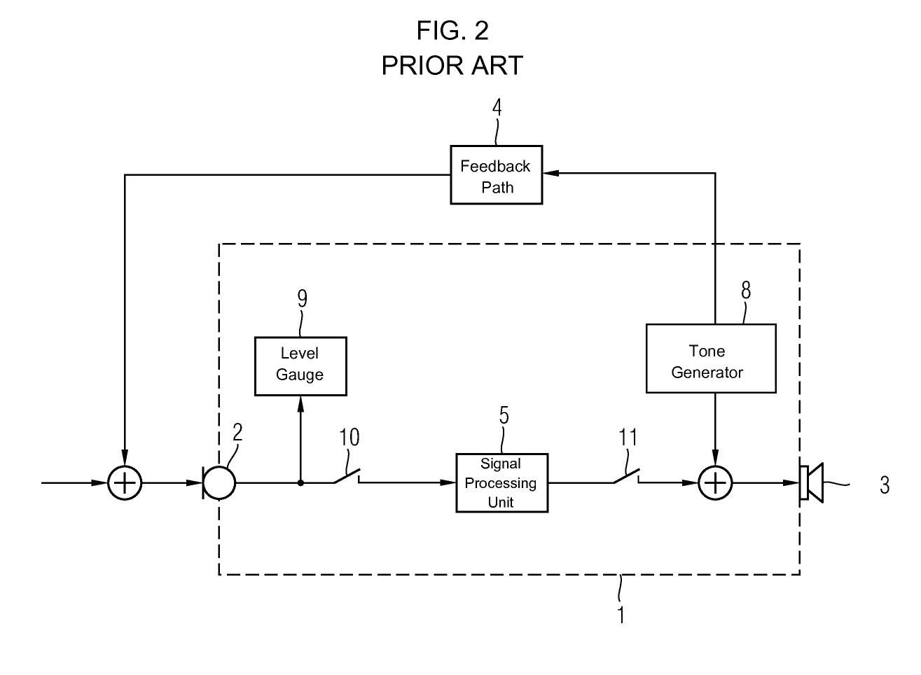

FIG. 3 is a schematic and block diagram of a hearing device for determining an OLG measurement according to the invention.

### DETAILED DESCRIPTION OF THE INVENTION

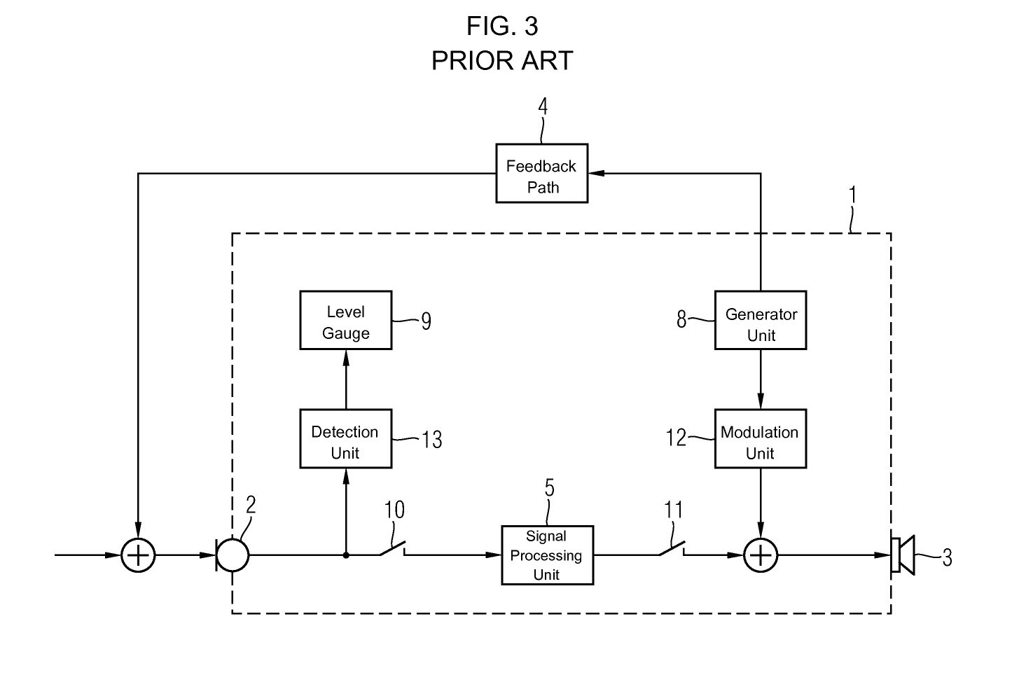

Referring now to the figures of the drawings in detail and first, particularly, to FIG. 3 thereof, there is seen a schematic and block diagram of a hearing device 1 for determining an OLG. The hearing device 1 includes a microphone 2 for receiving sound waves and for converting the sound waves into an electrical signal, a signal processing unit 5 for processing and amplifying the electrical signal and a receiver 3 and/or miniature loudspeaker for emitting the amplified electrical signal in the form of sound waves. One part of the amplified sound waves reaches the microphone 2 from the receiver 3 by way of a feedback path 4, thereby resulting in feedback.

In order to measure the maximum possible amplification without feedback whistling (=OLG), the signal path of the hearing device 1 is separated upstream and downstream of the signal processing unit 5 by first and second switches 10, 11. Downstream of the second switch 11, an electrical measuring signal generated by a generator unit 8, for instance a tone generator, is fed into the separated signal path and emitted as an acoustic signal by way of the receiver 3.

In accordance with the invention, the measuring signal is modulated in a modulation unit 12 downstream of the generator unit 8 and is thus emitted as a modulated measuring signal from the receiver 3. Amplitude modulation, phase modulation, frequency modulation and signal gap modulation with an occasional reduction in the amplitude to zero are considered as modulation methods.

The fed-back modulated measuring signal received by the microphone 2 is routed to a detection unit 13 upstream of the first switch 10. The detection unit 13 is attuned to the modulation of the modulation unit 12, and exclusively detects correspondingly modulated signals. Its level is then determined in a level gauge 9. A difference between this level and an original level of the test tones in the generator unit 8 is shown by the OLG. Restricting the detection to modulated signals prevents ambient noises received by the microphone 2 from negatively affecting the signal-to-noise ratio even with small levels of the measuring signal.

The emission and detection of the measuring signal is implemented separately in different sub bands.

1. A method for improving a signal-to-noise ratio of a measuring signal acoustically emitted and acoustically detected by a hearing device, the method comprising the following steps:
modulating the measuring signal through the hearing device prior to or during emission; and
detecting the acoustically emitted, modulated measuring signal through the hearing device on a basis of the modulation.

2. The method according to claim 1, which further comprises carrying out the modulating step by amplitude modulation.

3. The method according to claim 1, which further comprises carrying out the modulating step by reducing an amplitude to zero and thus by adding signal gaps.

4. The method according to claim 1, which further comprises carrying out the modulating step by phase modulation.

5. The method according to claim 1, which further comprises carrying out the modulating step by frequency modulation.

6. The method according to claim 1, which further comprises carrying out the step of detecting the measuring signal separately in different frequency bands.

7. The method according to claim 1, wherein the measuring signal is a measuring signal for an open-loop gain measurement.

8. A hearing device for acoustically emitting and for detecting a measuring signal, the hearing device comprising:
a generator unit for generating a measuring signal;
a modulation unit for modulating the measuring signal prior to or during emission, to modulate the detected measuring signal according to the generated measuring signal;
a detection unit for detecting the measuring signal on a basis of the modulation;
a receiver for acoustically emitting the modulated measuring signal; and
a microphone for receiving the modulated measuring signal emitted by the receiver.

9. The hearing device according to claim 8, wherein said modulation unit is configured for modulating the measuring signal in terms of at least one of its amplitude or phase or frequency.

10. The hearing device according to claim 8, wherein said modulation unit is configured for modulating the measuring signal by reducing an amplitude to zero and thus by adding signal gaps.

11. The hearing device according to claim 8, wherein the measuring signal is a measuring signal for an open-loop gain measurement.
